(19) United States
(12) Patent Application Publication
(10) Pub. No.: US 2024/0334259 A1
(43) Pub. Date: Oct. 3, 2024

(54) MUSIM SWITCHING IN MULTI-RAT DUAL CONNECTIVITY

(71) Applicant: Nokia Technologies Oy, Espoo (FI)

(72) Inventors: Srinivasan SELVAGANAPATHY, Bangalore (IN); Aby KANNEATH ABRAHAM, Bangalore (IN); Faranaz SABOURI-SICHANI, Aalborg (DK)

(21) Appl. No.: 18/554,280

(22) PCT Filed: May 4, 2022
(86) PCT No.: PCT/EP2022/061907

§ 371 Date: Oct. 6, 2023

(30) Foreign Application Priority Data
May 7, 2021 (IN) 202141020801

(51) Int. Cl. H04W 36/00

(52) U.S. Cl. CPC H04W 36/0027

(57) ABSTRACT

In some example embodiments, there may be provided a method that includes sending, by a user equipment, a request to a first radio access network to switch a first connection of a dual connection, which is being used by a first user equipment instance of a first subscriber identity module at the user equipment, to a suspended state at the first radio access network while continuing use of a second connection of the dual connection by the first user equipment instance; and receiving, by the user equipment, a response indicating the first connection is suspended. Related systems, methods, and articles of manufacture are also disclosed.

### FIELD

The subject matter described herein relates to wireless communications.

### BACKGROUND

In 5G's New Radio (NR), the system may operate with beam based operation at above the 6 GHz carrier frequency range as well as below 6 GHz. When this is the case, the transmitter and the receiver may operate using spatial domain beamforming (e.g., in the analog domain, in the digital domain, or a combination of both) to cover the propagation loss associated with the radio channel. Moreover, the user equipment may include multiple receive antenna panels, in which each antenna panel includes an antenna element and/or a beamforming module. Depending on the user equipment's reception capability, a set of antenna panels (at the user equipment) may be used for simultaneously reception of a downlink from the network, such as a gNB base station or other type of cellular base station.

### SUMMARY

In some example embodiments, there may be provided a method that includes sending, by a user equipment, a request to a first radio access network to switch a first connection of a dual connection, which is being used by a first user equipment instance of a first subscriber identity module at the user equipment, to a suspended state at the first radio access network while continuing use of a second connection of the dual connection by the first user equipment instance; and receiving, by the user equipment, a response indicating the first connection is suspended.

In some variations, one or more of the features disclosed herein including the following features can optionally be included in any feasible combination. The request may be sent in response to a move, or a need to move, to a radio resource connection by a second user equipment instance of a second subscriber identity module at the user equipment. The request may include at least one of the following: a reason for the switch; an indication including a second user equipment instance of a second SIM connecting to the first radio access network; and an indication that the first user equipment instance is able to maintain radio link monitoring via the second user equipment instance of the second subscriber identity module. The response may include at least one of the following: an indication to map radio link monitoring information of a second user equipment instance to the first user equipment instance; and an indication to continue radio resource management measurement and reporting as configured for the first user equipment instance. During the suspended state of the first connection of the dual connection, the first user equipment instance of the first subscriber identity module may continue operation on the second connection of the dual connection. The first user equipment instance may perform radio resource management measurements and reporting based on at least one of the following: one or more measurements obtained from the second user equipment instance; and one or more measurements obtained during one or more short gaps in the radio resource connection of the second user equipment instance. The radio resource connection of the second user equipment instance may be to the first radio access network. The radio resource connection of the second user equipment instance may be to a second radio access network that is in a different public land mobile network than the first radio access network that provides the dual connection to the first user equipment instance. The resumption of the first connection of the dual connection may be requested via the second connection or a scheduling request for radio resources. The request for resumption may be in response to a radio resource connection being released for a second user equipment instance of a second subscriber identity module at the user equipment. The first user equipment instance may be in dual connectivity with a eNB base station operating as a master node and a gNB base station operating as a secondary node.

In some example embodiments, there may be provided a method that includes receiving, at a first radio access network, a request to switch a first connection of a dual connection, which is being used by a first user equipment instance of a first subscriber identity module at the user equipment, to a suspended state at the first radio access network while the first user equipment instance of the first subscriber identity module at the user equipment continues use of a second connection of the dual connection; and sending, by the first radio access network, a response to indicate the first connection is suspended.

In some variations, one or more of the features disclosed herein including the following features can optionally be included in any feasible combination. The request may be received in response to a move, or a need to move, to a radio resource connection by a second user equipment instance of a second subscriber identity module at the user equipment. The received request may include at least one of the following: a reason for the switch; an indication including a second user equipment instance of a second SIM connecting to the first radio access network; and an indication that the first user equipment instance is able to maintain radio link monitoring via the second user equipment instance of the second subscriber identity module. The response may include at least one of the following: an indication to map radio link monitoring information of a second user equipment instance to the first user equipment instance; and an indication to continue radio resource management measurement and reporting as configured for the first user equipment instance. Reporting may be received based on at least one of the following: one or more measurements obtained from the second user equipment instance; and one or more measurements obtained during one or more short gaps in the radio resource connection of the second user equipment instance. A resumption request for the first connection of the dual connection may be received via the second connection or a scheduling request for radio resources. The request for resumption may be in response to a radio resource connection being released for a second user equipment instance of a second subscriber identity module at the user equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIGS. 1A-1B depict examples of the control plane connectivity for dual connectivity, in accordance with some example embodiments;

FIG. 1C depicts an example of the user plane connectivity for dual connectivity, in accordance with some example embodiments;

FIG. 1D depicts an example of a signaling flow for a dual connectivity user equipment configured with MUSIM, in accordance with some example embodiments;

FIG. 2 depicts a signaling diagram for intra-PLMN dual connectivity, in accordance with some example embodiments;

FIG. 3 depicts a signaling diagram for inter-PLMN dual connectivity, in accordance with some example embodiments;

FIG. 4A depicts an example of a network node, in accordance with some example embodiments; and

FIG. 4B depicts an example of an apparatus, in accordance with some example embodiments.

Like labels are used to refer to same or similar items in the drawings.

### DETAILED DESCRIPTION

The subject matter disclosed herein relates to a user equipment (UE) supporting multiple subscriber identity modules (SIMs) including, for example, multiple U-SIM (MUSIM). The acronym “U-SIM” refers to a universal subscriber identity module, and although the U-SIM is referred to in some of the examples described herein, other types of subscriber identity modules may be used as well. The subject matter disclosed herein also relates to the coordinated departure, or leaving, of a user equipment (UE) configured with MUSIM and, in particular, how to allow this MUSIM UE to leave the network in a coordinated manner (e.g., while minimizing waste of the network's resources) and/or how the network handles mobile terminated (MT) data or MT control-plane activity, when the MUSIM UE has left. Moreover, the subject matter disclosed herein may relate to mechanisms for the UE to notify a network of a switch among the MUSIM at the UE.

When the New Radio (NR, also referred to herein as 5G) technology is initially introduced into an area having an earlier radio access technology (RAT) such as LTE, the network operator may provide non-standalone mode operation. In the non-standalone mode of operation, the NR access network may be used as a secondary node of a radio resource control (RRC) connection with dual connectivity, while the master node for the dual connectivity is in the earlier RAT (e.g., an LTE base station such as an eNB base station and the core network provided by the Evolved Packet Core (EPC)), for example. In these types of deployment scenarios, the MUSIM UE may include a first USIM capable of LTE and a second USIM capable of EN-DC connectivity. The acronym “EN-DC” refers to E-UTRA-NR Dual Connectivity (EN-DC), which refers to dual connectivity with the master cell group in LTE (or E-UTRA) and the secondary cell group in NR.

In NR networks, there may be single connectivity, such as a standalone mode of operation or multi-connectivity, such as the noted non-standalone operation (e.g., a multi-radio access technology-dual connectivity, MR-DC), which may be defined by EN-DC, NGEN-DC (NG-RAN E-UTRA-NR Dual Connectivity), and/or NR-DC (NR Dual Connectivity). In the case of dual or multi-connectivity in NR, the user equipment (UE) may support at least two independent transceivers (e.g., TX/RX), although the UE may include only a single transceiver as well.

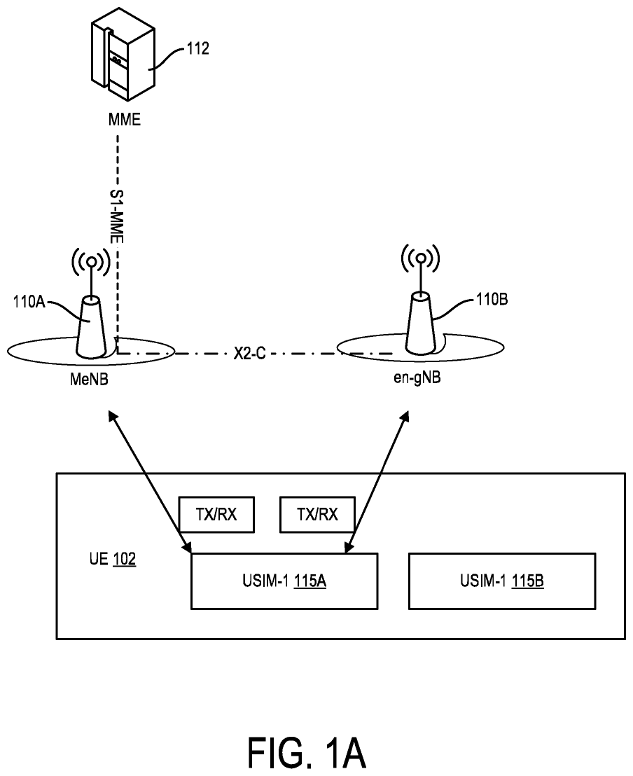

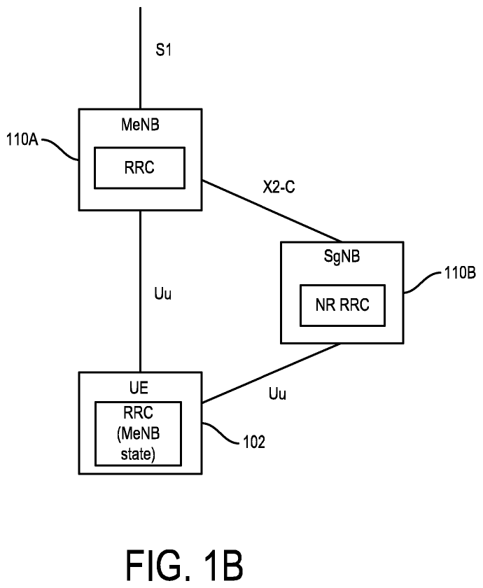

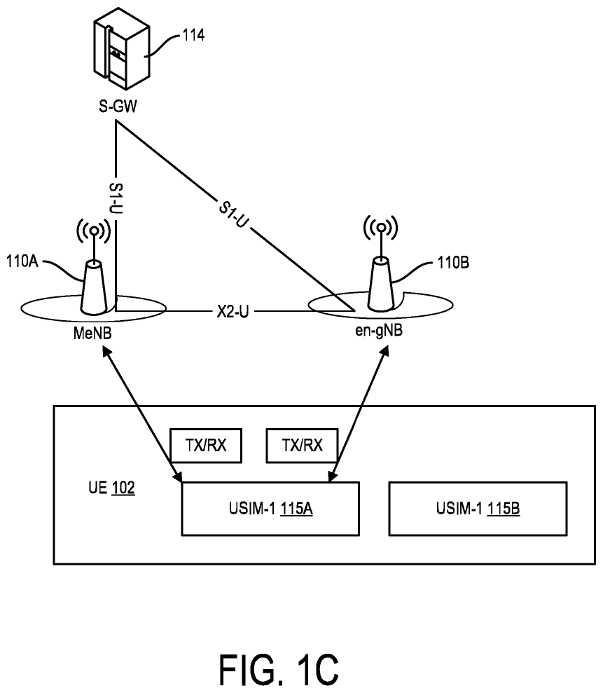

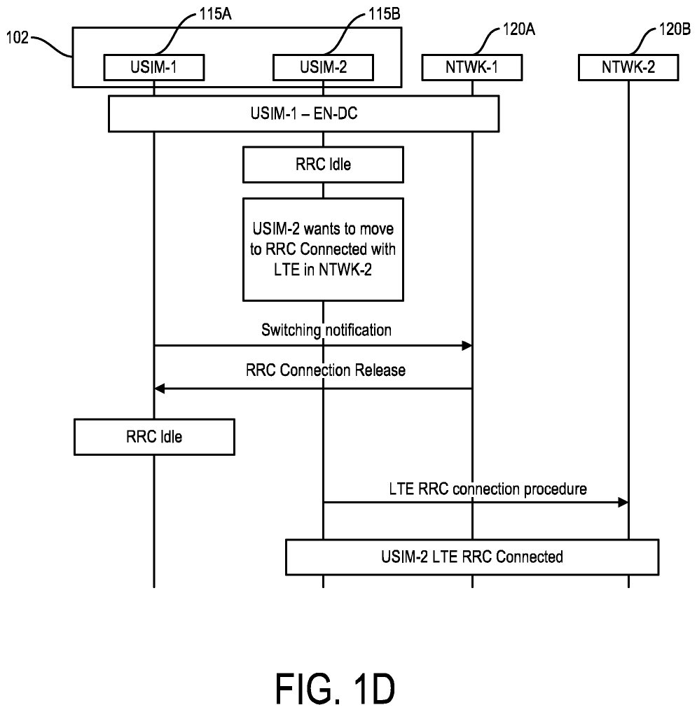

FIGS. 1A-1B depict an example of the control plane connectivity for EN-DC, in accordance with some example embodiments. In the example of FIGS. 1A-1B, the UE 102 (which includes in this example at least one USIM, such as USIM 115A and USIM 115B) may include multiple transceivers. And, the UE may be connected at the same time to an LTE radio access node (e.g., an eNB 110A type base station) and a 5G radio access node (e.g., gNB 110B type base station), while the EPC is used as a core network. The eNB 110A acts as a dual connectivity Master Node (MeNB, serving a master cell group), and the gNB 110B acts as a dual connectivity Secondary Node (en-gNB, serving a secondary cell group). The master cell group may include one or more cells. And, the secondary cell group may include one or more cells as well. In EN-DC, the user plane data traffic may be split between the eNB 110A and the gNB 110B.

In EN-DC however, the control plane traffic for the dual connectivity is through the LTE master node, which in this example is eNB 110A. The S1 interface for the control plane (S1-MME) is between eNB 110A and MME 112, and the control plane signaling towards the UE may be through both eNB 110A and gNB 110B as shown at FIG. 1B. Each of the eNB and gNB may have its own radio resource control (RRC), which generates RRC protocol data units (PDUs) and can be transferred to the UE. The master node (which in this example is eNB 110A) may maintain the RRC state, and may transport the initial secondary node (e.g., which in this example is gNB 110B) RRC reconfiguration. This initial secondary node reconfiguration may be sent via master cell group (MCG) signaling radio bearers (SRB, such as SRB1), but subsequent reconfigurations may be transported via the master node (e.g., the M-eNB) or secondary node (e.g., en-gNB). The SRB refers to a radio bearer used for transmission of RRC and network access stratum (NAS) messages, and SRB1 refers to a type of SRB message (e.g., used for the transport of RRC messages including piggybacked NAS messages and NAS messages prior to the establishment of SRB2).

FIG. 1C depicts an example of the user plane connectivity for EN-DC including a serving gateway (S-GW) 114, in accordance with some example embodiments. In the user plane, the bearers allocated to a UE may include a master cell group (MCG) bearer, a secondary cell group (SCG) bearer, and a split bearer. From the UE 102 perspective, the network may configure an E-UTRA packet data convergence protocol (PDCP) or a NR PDCP for master node terminated MCG bearers, while the NR-PDCP is used for all other bearers. From a network perspective, each of the noted bearers can be terminated either in the master node or in the secondary node. The UE may suspend the master cell group during a radio link failure (e.g., an MCG-RLF), in which case the UE may send (via for example signaling bearers, such as SRB3 or split SRB-1) a failure indication (e.g., MCGFailureInformation) and may start a timer such as the T316. The network may use the RRC reconfiguration to restore the MCG (see, e.g., (TS 37.340-V16.40)). If the master cell group (MCG) is not restored within the configured time (e.g., before the expiration of the T316 timer), the UE may trigger a RRC reestablishment and the link may be restored.

FIG. 1D depicts the UE 102 configured with MUSIM, so the first USIM-1 115A and the second USIM-2 115B are depicted including the first network 120A and the second network 120B. The first USIM-1 115A is configured to support EN-DC. Consider, however, the first USIM 115A is in an RRC-CONNECTED dual connectivity state, such as EN-DC. When the first USIM 115A (e.g., a UE instance or portion of the UE using the first USIM 115A to access the first network 120A) is in the EN-DC, the first network 120A includes a master node (e.g., master eNB, MeNB), a secondary node (e.g., SgNB or en-gNB), and a core network. And, the second USIM 115B (e.g., a UE instance or portion of the UE using the second LTE USIM 115B to access the second network 120B which is LTE in this example) includes an eNB (e.g., an LTE base station) and a core network. This second USIM 115B moves from an RRC-IDLE state to an RRC-CONNECTED state. As such, the UE 102 may want to establish an RRC connection in the second USIM 115B and thus needs to leave the first network 120A, so the RRC connection at the first USIM 115A is released. The UE may send a switching notification to the first network 120A and the RRC connection will be released by releasing both the master cell group (MCG) and the secondary cell group (SCG). The UE may then start the RRC connection establishment with the second network 120B. However, this means that the UE will not be able to maintain the connection for the first USIM 115A, when the second network 120B is connected. In some embodiments, there is provided a solution to address how the MUSIM UE with EN-DC capability on at least one USIM can initiate the RRC connection in the second USIM without completely releasing the connection with the first USIM.

In some example embodiments, a UE (which is dual connected such as in the EN-DC and which is a MUSIM device) in an RRC-CONNECTED state may be moved by the network to a state in which the master cell group (MCG) is suspended at the network. This suspended MCG state may be referred to herein as MCG-NW-SUSPENDED state. The MCG-NW-SUSPENDED state may be provided, during a switching procedure where the UE intends to establish an RRC connection to another network, and the network intends (1) to release the MCG radio resources and (2) to maintain the secondary cell group (SCG)-enabling thus the switch without leaving the RRC-CONNECTED state of the master cell group. The suspension disclosed herein may refer to a suspension (requested by the UE), such that the UE will not be scheduled for any uplink and/or downlink on the suspended connection to the master cell group. As such, the UE may use its resources (e.g., hardware and software resources such as transceivers, etc.) to establish connection via the second USIM 115B.

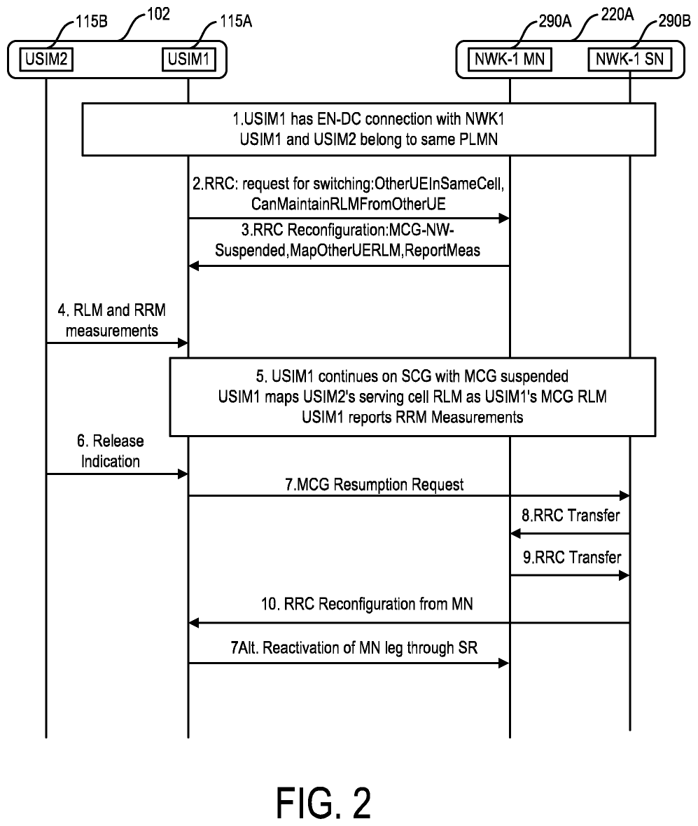

FIG. 2 depicts a signaling diagram for the intra-PLMN use case, in accordance with some example embodiments. The phrase “intra-PLMN use case” refers to the multiple USIMs at the UE being associated with, or belonging to, the same network operator (e.g., network provider) or the same public land mobile network. Moreover, FIG. 2 depicts the UE 102 including multiple USIMs (MUSIM), which in this example are the first USIM 115A (USIM1) and the second USIM 115B (USIM2).

In the example of FIG. 2, the MUSIM UE 102 includes the first USIM 115A (which comprises a first UE instance associated with the first USIM) in an EN-DC connected state and includes the second USIM 115B (which comprises a second UE instance associated with the second USIM and which, in this example, is a USIM configured for an LTE network). The first network 220A includes a master node 290A (e.g., an LTE eNB or MeNB) serving a master cell group or a primary cell (also referred to as a master cell or master cell group) and a second node 290B a NR gNB serving a secondary cell group or a secondary cell.

At FIG. 2, the UE's second USIM 115B is moving from an RRC idle or RRC inactive state to an RRC connected state, so the UE 102 will need access to LTE radio resources at the eNB provided by the master node 290A of the first network 220A.

At 1, the UE's 102 first USIM 115A is in dual connectivity (which in this example is EN-DC, so there is a first connection to a master node 290A (e.g., an LTE eNB) and a second link to a secondary node 290B (e.g., a NR gNB) with the first network 220A. As noted, the first and second USIMs 115A-B belong to the same operator or PLMN.

At 2, the UE's 102 instance corresponding to the first USIM 115A may send to the first network 220A (and in particular the master node (MN) 290A) a switching notification in order to leave the primary cell (PCell) of the first network 220A to enable the UE's second instance associated with the second USIM 115B to access that same, primary cell at 290A. The switching notification at 2 may also indicate the reason for the switch. For example, the reason for the switch may be the second USIM 115B requesting establishment of an RRC connection such as the master node 290A (or, e.g., the master cell group (MCG) associated with, or served by, the master node 290A such as an LTE master eNB).

At 2, the second USIM 115B may also be instructed to indicate (to the network 220A) that connection establishment is on the same, primary cell as the first USIM 115A master cell group (MCG) at 290A. In the example of FIG. 2, RRC information element “OtherUEInSameCell” is used to indicate the second USIM 115B requests an RRC connection to the same cell as the master cell group being used by the first USIM 115A.

The switching notification sent at 2 may also indicate the UE's 102 capability with respect to monitoring and/or measurement reporting during the suspension. For example, the UE may indicate that the UE can maintain radio link monitoring (RLM) status using the second USIM 115B (which may be supported as the first and second USIMs belong to same PLMN). In the example of FIG. 2, the switching sent notification at 2 includes “CanMaintainRLMFromOtherUE” to indicate to the network that UE 102/first USIM 115A can, during the suspension, maintain radio link monitoring (RLM) via the second USIM 115B (e.g., the second UE instance at UE 102 operating via the second USIM 115B).

At 3, the master node 290A of the first network 220A may then move the UE 102 instance for the first USIM 115A to the suspended state, such as the “MCG-NW-SUSPENDED” depicted at FIG. 2 at 3. While in this suspended state, the master cell group (MCG) of the dual connectivity may be considered suspended from the perspective of the network. But from the perspective of the UE 102, the UE may continue, as shown at 4 for example, radio link monitoring (RLM) and/or radio resource management (RRM) measurements (which may be obtained via internal UE exchange(s) across the USIMs 115A-B).

At 3, the master node 290A of the first network 220A may also request the UE 102 to map or use the radio link monitoring (RLM) of the second USIM 115B as the UE's own RLM and thus continue with the configured radio resource management (RRM) reports (e.g., event reporting, such as A3, and/or the like). The master node 290A may also request the UE 102 to continue radio resource management (RRM) measurement reports (including, for example, those RRM reports related to the second USIM's serving cell which is the same as first USIM primary cell/master cell group). In the example of FIG. 2 at 3, the message (which in this example is an RRC reconfiguration message) indicates “MapOtherUERLM” to indicate to the UE to use the other USIM's 115B RLM for the RLM of the first USIM/UE and “ReportMeas” to indicate to the UE to continue the configured measurement reporting.

On the connection setup between the eNB at 290A and the second USIM 115B, the UE 102 including the second USIM 115B may start, at 4, to perform radio link monitoring (RLM) for its serving cell (which as noted is the same as first USIM's primary cell/master cell group). This status may be internally reflected to the master cell group radio link monitoring of the first USIM 115A as well.

During the suspended state of the master cell group of the first USIM 115A, the UE 102 including the first USIM 115A may continue, at 5, to operate on the secondary cell group (e.g., secondary cell(s) of the dual connectivity provided by the secondary node(s) 290B of the first network 220A). During the suspension, the UE 102 may, at 5, continue to the first network 220A measurement reporting, such as event reporting and the like (which are based on measurements made via the UE 102 and second USIM 115B).

When the UE 102 releases the second USIM's 115B connection at 6, the master cell group (MCG) of the first USIM 115A (which was suspended) may be resumed at 7 by sending a request (e.g., via a SRB3 or a split-SRB). In the example of FIG. 2, the UE may send a request to resume the suspended master node (or MCG) at 290A by, for example, sending the request to the secondary cell group (e.g., secondary node 290B of NR gNB, which as noted includes an interface to the master cell group/MeNB). In response to the resumption request at 7, the first network 220A may, at 8-10, resume and thus end the suspension of the master node/master cell group 290A. And, the UE may receive via the RRC reconfiguration an indication of the resumption of the master cell group. Alternatively, or additionally, the master cell group of the first USIM 115A may be reactivated or resumed, at 7Alt, by the having the UE trigger the reactivation (or resumption) via a scheduling request (SR) of the master cell group (MCG), if the UE was reconfigured with scheduling request resources on the latest MCG. In other words, upon receiving the scheduling request, the master node (MeNB) may restart the scheduling on the master cell group, thereby ending the MCG-NW-SUSPENDED state. When master cell group is suspended, communications from/to the UE may, as noted, be via the secondary cell group using one or more RRC message(s). Alternatively, or additionally, the UE may request resources via a scheduling request (SR) or other type of message (e.g., a network access stratum (NAS) message).

As noted with respect to FIG. 2, while requesting to leave, the first USIM 115A may indicate to the first network 220A the UE's capability for maintaining radio link monitoring and may indicate that the second USIM 115B is camped to the same cell as the first USIM 115A. In an RRC message such as RRC reconfiguration message, the first network may suspend the master cell group. This RRC reconfiguration message may confirm that the UE can map the second USIM's radio link monitoring and continue report as configured by the master node. The first USIM (e.g., the UE 102's instance for the first USIM) may continue communications on the secondary cell group, while the master cell group is suspended. Moreover, the first USIM may map the second USIM's radio link monitoring to its own master cell group. Furthermore, the first USIM may report its measurements to the first network based on the second USIM's (e.g., the UE 102's instance for the second USIM) RRC measurements in accordance with previously configured measurement parameters and reporting events, for example. If a primary cell (Pcell) handover is necessary (e.g., based on A3 event or for another USIM), the network may prepare for a request to a target primary cell, but will only trigger the request if the UE master cell group is resumed; otherwise, the first network may release the suspended RRC connection. In other words, if the UE undergoes a handover in the second USIM, it is expected that the old primary cell (which is suspended) will not be a good target cell for the master cell group when the UE returns. Although the handover of a suspended MCG may not be triggered, preparation for the handover may take place such that the handover can be triggered as soon as the UE is back and resumes the master cell group (which was suspended). When the second USIM is released, the first USIM may resume operation on the master cell group by sending a master cell group resumption request or by a scheduling request when it is configured in the MCGConfig for the same cell.

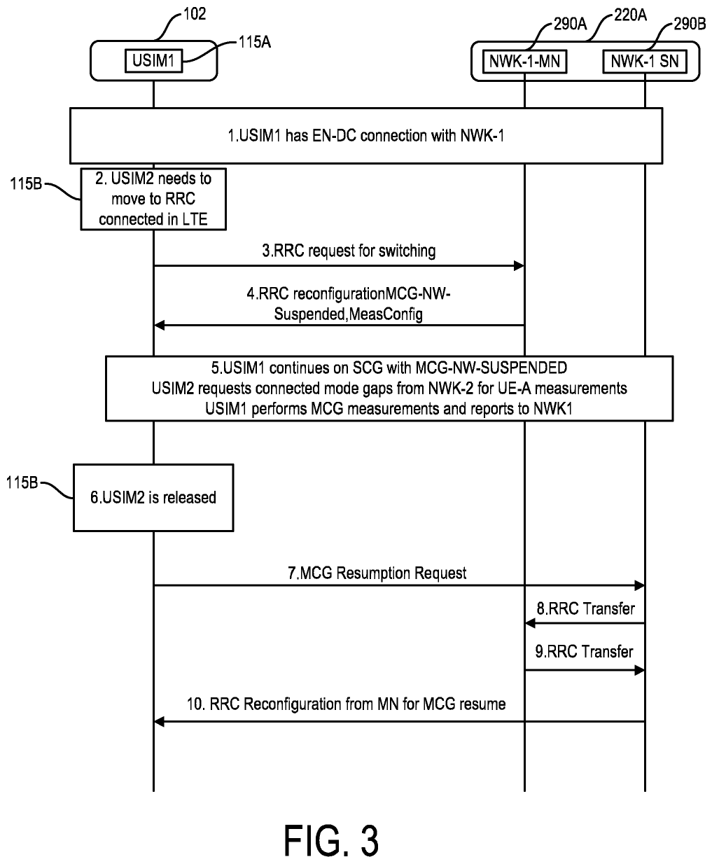

If there is a radio link failure at the MCG at 290A or the SCG at 290B, the RRC connection may be released. The first network's master node 290A may route, via the secondary node 290B, NAS messages, reconfigure the MCG configuration, or release the RRC connection. FIG. 3 depicts a signaling diagram for the inter-PLMN use case, in accordance with some example embodiments. The phrase “inter-PLMN use case” refers to the multiple USIMs at the UE being associated with, or belonging to, different network operators (e.g., network providers) or different public land mobile networks. In the example of FIG. 3, the switching optimizations for EN-DC are with respect to the inter-PLMN use case, although the inter-PLMN process described with respect to FIG. 3 may also be used for the intra-PLMN use case noted above.

At 1, the UE 102 includes an instance with the first USIM 115A, and this first USIM 115A has a dual connectivity connection, such as the EN-DC connection, with the first network 220A. This first network 220A provides at least a master node 290A (e.g., an MeNB) and a secondary node 290B (e.g., en-gNB).

At 2, the second USIM 115B of the UE 102 (e.g., a UE instance of the second USIM 115B) needs to move from an RRC idle state to an RRC connected state (e.g., with a eNB), but the first USIM 115A is using the LTE transceiver capability for the master node 290A link of the EN-DC. Unlike FIG. 2, the second USIM 115B at FIG. 3 belongs to another network operator/PLMN, so the second USIM 115B is connected to another PLMN/operator network. In order to accommodate the switch at 2, the UE instance for the first USIM 115A may send, at 3, a switching notification to the network 220A (e.g., the master node 290A) in order to leave the primary cell (e.g., the master node or master cell group at 290A) and in order to initiate the connection setup in the second USIM 115B. Unlike FIG. 2, the second USIM is connecting to another cell at another provider's network (e.g., another PLMN).

At 4, the first network 220A (e.g., master node 290A) may then move the UE 102 instance for the first USIM 115A to the suspended state, such as the MCG-NW-SUSPENDED state. At 4, the master node may send a message, such as a RRC reconfiguration message, to the first USIM 115A (e.g., a UE instance at 102 for the first USIM) to indicate the suspended state of the master cell group/master node 290A being used by the first USIM 115A.

At 4, the master node 290A may also configure the first USIM 115A with RRM measurement configurations. Moreover, the master node 290A may request the first USIM 115A to provide reporting as well. In the example of FIG. 3 at 4, the message (which in this example is an RRC reconfiguration message) indicates “MCG-NW-SUSPENDED” to indicate to the UE the suspension and “MeasConfig” to represent continuation of the RRM measurement configurations.

Moreover, the first network 220A (e.g., master node 290A) may configure, at 4, the validity of the suspended state, such that the suspension is valid (e.g., in effect) until there is a change (as detected by UE 102) of the serving cell in the first network.

On RRC connection setup in the second USIM 115B, the first USIM 115A may, at 5, continue (while in the suspended state) on the secondary cells (which are provided by the secondary cell group at the secondary node 220B such as a gNB). And, the first USIM 115A may monitor the master cell group/master node 290A using one or more short gaps in the RRC connected mode of the second USIM 115B. During these short gaps, the first USIM 115A may measure and report to the first network 220A using, for example, SRB3 or split SRB via the secondary cell group leg at 220B. During the suspension, the first USIM 115A may continue to use the secondary cell group leg at 220B (which is via 5G, for example).

Based on reporting received from the first USIM 115A during the suspension of the master cell group/master node 290A, the first network 220A may take specific actions. For example, the first network may prepare a target master cell group for a possible handover and then trigger a handover of the primary cell (PCell) to the target if the UE requests resume within the T316 timer. The first network may release the RRC connection (which was suspended) if the UE does not return (e.g., resume use of the MCG) in time to execute the primary cell handover. When this is the case, the first network may send an RRC release. In other words, the UE continues RRM measurements and reports to the MCG (e.g., via SCG). As the primary cell is suspended, no actions can be taken, but the master node may still identify a need for a handover and prepare for the handover (including start of a timer, etc.). If the UE returns and resumes the MCG, the handover may be triggered immediately after, but if the timer expires before the UE returns, the network knows that a handover may be too late and just release (e.g., move from suspend to full release) the suspended MCG.

If there is a radio link failure (RLF) associated with the secondary cell group or the master cell group moves to out of service (OOS), the suspended RRC connection will be released by the first network. The first USIM's master node radio resource control may remain under the control of the master node (e.g., the eNB master node 290A of the first network 220A) but in a suspended state (e.g., MCG-NW-Suspended). The first network may, as noted, send any RRC message(s) through a split SRB or a SRB3 to the first USIM (e.g., for transferring any NAS messages, reconfiguring measurements, moving the RRC to idle/inactive mode). On receiving a measurement report, the master node 290A may decide to release the first USIM 115A instance.

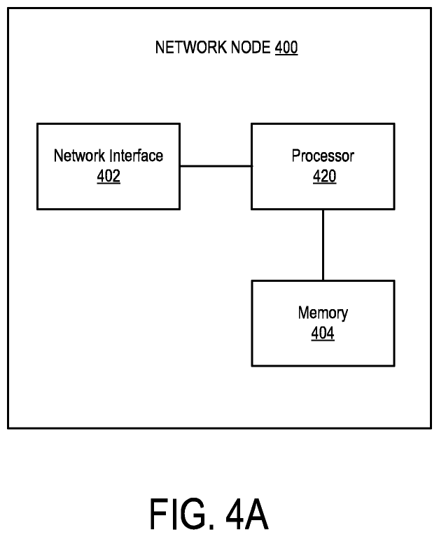

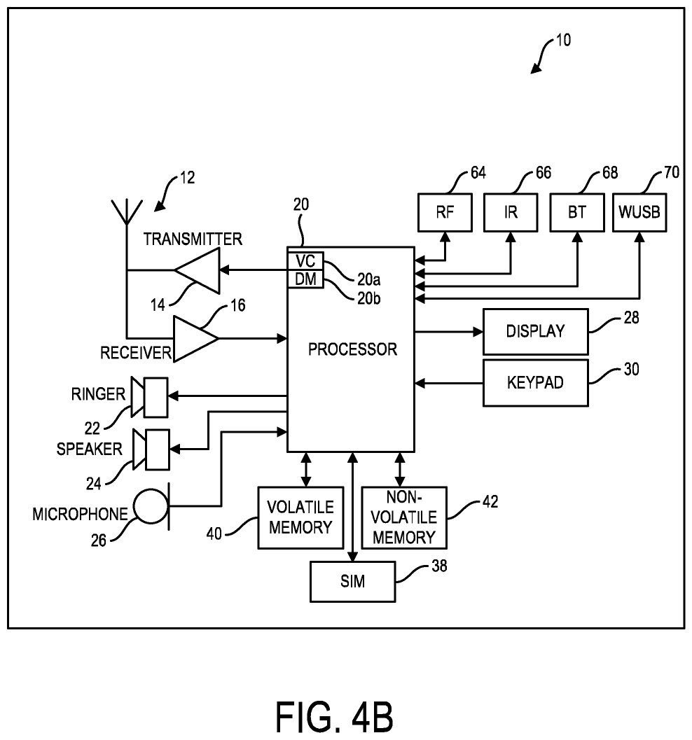

FIG. 4A depicts a block diagram of a network node 400, in accordance with some example embodiments. The network node 400 may be configured to provide one or more network side nodes or functions, such as a base station (e.g., gNB, eNB, and/or the like). The network node may be configured to provide a network node, such as a base station (e.g., eNB, gNB, etc.).

The network node 400 may include a network interface 402, a processor 420, and a memory 404, in accordance with some example embodiments. The network interface 402 may include wired and/or wireless transceivers to enable access other nodes including base stations, other network nodes, the Internet, other networks, and/or other nodes. The memory 404 may comprise volatile and/or non-volatile memory including program code, which when executed by at least one processor 420 provides, among other things, the processes disclosed herein with respect to the network nodes. For example, the network node may be configured as a base station (e.g., a MeNB, en-gNB, etc.) and may be configured to perform one or more of the operations disclosed with respect to FIGS. 2 and 3. For example, the network node 400 may receive a request to switch a first connection of a dual connection, which is being used by a first user equipment instance of a first subscriber identity module at the user equipment, to a suspended state at the first radio access network while the first user equipment instance of the first subscriber identity module at the user equipment continues use of a second connection of the dual connection; and send.

FIG. 4B illustrates a block diagram of an apparatus 10, in accordance with some example embodiments. The apparatus 10 may represent a user equipment. The user equipment may be configured to provide the MUSIM UE 102. The UE may include one or more instances. For example, a portion of the UE's resources at FIG. 4B may be used for a first UE instance accessing a radio access network via a first SIM, and a portion of the UE's resources at FIG. 4B may be used for a second UE instance accessing a radio access network via a second SIM.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4B as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 4B, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, U-SIM, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the UE (e.g., one or more of the processes, calculations, and the like disclosed herein including the process at FIGS. 2 and 3) For example, user equipment may be configured to at least send a request to a first radio access network to switch a first connection of a dual connection to a suspended state at the first radio access network while continuing use of a second connection of the dual connection, wherein the dual connection is being used by a first user equipment instance of a first subscriber identity module at the user equipment. The user equipment may also be configured to receive a response indicating the first connection is suspended.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiments, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may include the UE being able to maintain a secondary cell group connection and the secondary cell group/split DRBs in EN-DC, when the master node radio frequency is being used by the UE's other USIM; and a faster reactivation of master node connectivity (or leg) when the radio frequency is released by the other USIM.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1. A method comprising:
sending, by a user equipment, a request to a first radio access network to switch a first connection of a dual connection, which is being used by a first user equipment instance of a first subscriber identity module at the user equipment, to a suspended state at the first radio access network while continuing use of a second connection of the dual connection by the first user equipment instance; and
receiving, by the user equipment, a response indicating the first connection is suspended.

2. The method of claim 1, wherein the request is sent in response to a move, or a need to move, to a radio resource connection by a second user equipment instance of a second subscriber identity module at the user equipment.

3. The method of claim 1, wherein the request further includes at least one of the following: a reason for the switch: an indication including a second user equipment instance of a second subscriber identity module connecting to the first radio access network; and an indication that the first user equipment instance is able to maintain radio link monitoring via the second user equipment instance of the second subscriber identity module.

4. The method of claim 1-3, wherein the response further includes at least one of the following: an indication to map radio link monitoring information of a second user equipment instance to the first user equipment instance; and an indication to continue radio resource management measurement and reporting as configured for the first user equipment instance.

5. The method of claim 1-4, wherein during the suspended state of the first connection of the dual connection, the first user equipment instance of the first subscriber identity module continues operation on the second connection of the dual connection.

6. The method of claim 4-5, wherein the first user equipment instance performs radio resource management measurements and reporting based on at least one of the following: one or more measurements obtained from the second user equipment instance; and one or more measurements obtained during one or more short gaps in the radio resource connection of the second user equipment instance.

7. The method of claim 2, wherein the radio resource connection of the second user equipment instance is to the first radio access network, or wherein the radio resource connection of the second user equipment instance is to a second radio access network that is in a different public land mobile network than the first radio access network that provides the dual connection to the first user equipment instance.

8. The method of claim 1, further comprising:
requesting, via the second connection or a scheduling request for radio resources, a resumption of the first connection of the dual connection.

9. The method of claim 8, wherein the request for resumption is in response to a radio resource connection being released for a second user equipment instance of a second subscriber identity module at the user equipment, and/or wherein the first user equipment instance in in dual connectivity with a eNB base station operating as a master node and a gNB base station operating as a secondary node.

10-15. (canceled)

16. An apparatus comprising:
at least one processor; and
at least one memory including computer program code, the at least one memory and the computer program code configured to, with the at least one processor, cause the apparatus to at least:
send, by a user equipment, a request to a first radio access network to switch a first connection of a dual connection, which is being used by a first user equipment instance of a first subscriber identity module at the user equipment, to a suspended state at the first radio access network while continuing use of a second connection of the dual connection by the first user equipment instance; and
receive a response indicating the first connection is suspended.

17. The apparatus of claim 16, wherein the request is sent in response to a move, or a need to move, to a radio resource connection by a second user equipment instance of a second subscriber identity module at the apparatus.

18. The apparatus of claim 16, wherein the request further includes at least one of the following: a reason for the switch; an indication including a second user equipment instance of a second subscriber identity module connecting to the first radio access network; and an indication that the first user equipment instance is able to maintain radio link monitoring via the second user equipment instance of the second subscriber identity module.

19. The apparatus of claim 16, wherein the response further includes at least one of the following: an indication to map radio link monitoring information of a second user equipment instance to the first user equipment instance; and an indication to continue radio resource management measurement and reporting as configured for the first user equipment instance.

20. The apparatus of claim 16, wherein during the suspended state of the first connection of the dual connection, the first user equipment instance of the first subscriber identity module continues operation on the second connection of the dual connection.

21. The apparatus of claim 19, wherein the first user equipment instance performs radio resource management measurements and reporting based on at least one of the following: one or more measurements obtained from the second user equipment instance; and one or more measurements obtained during one or more short gaps in the radio resource connection of the second user equipment instance.

22. The apparatus of claim 17, wherein the radio resource connection of the second user equipment instance is to the first radio access network, or wherein the radio resource connection of the second user equipment instance is to a second radio access network that is in a different public land mobile network than the first radio access network that provides the dual connection to the first user equipment instance.

23. The apparatus of claim 16, wherein the apparatus is further caused to at least request, via the second connection or a scheduling request for radio resources, a resumption of the first connection of the dual connection, and/or wherein the request for resumption is in response to a radio resource connection being released for a second user equipment instance of a second subscriber identity module at the apparatus, and/or wherein the first user equipment instance in in dual connectivity with a eNB base station operating as a master node and a gNB base station operating as a secondary node.

24. An apparatus comprising:
at least one processor; and
at least one memory including computer program code, the at least one memory and the computer program code configured to, with the at least one processor, cause the apparatus to at least:
receive a request to switch a first connection of a dual connection, which is being used by a first user equipment instance of a first subscriber identity module at the user equipment, to a suspended state at a first radio access network while the first user equipment instance of the first subscriber identity module at the user equipment continues use of a second connection of the dual connection; and
send a response to indicate the first connection is suspended.

25. The apparatus of claim 24, wherein the request is received in response to a move, or a need to move, to a radio resource connection by a second user equipment instance of a second subscriber identity module at the user equipment.

26. The apparatus of claim 24, wherein the received request further includes at least one of the following: a reason for the switch; an indication including a second user equipment instance of a second subscriber identity module connecting to the first radio access network; and an indication that the first user equipment instance is able to maintain radio link monitoring via the second user equipment instance of the second subscriber identity module.

27-35. (canceled)
